(19) United States
(12) Patent Application Publication
(10) Pub. No.: US 2007/0256772 A1
(43) Pub. Date: Nov. 8, 2007

(54) Tire for heavy vehicles

(75) Inventor: Olivier Ferlin, Malauzat (FR)

Correspondence Address: COHEN, PONTANI, LIEBERMAN & PAVANE, 551 FIFTH AVENUE, SUITE 1210, NEW YORK, NY, 10176, US

(73) Assignee: Michelin Recherche et Technique S.A., Granges-Paccot (CH)

(21) Appl. No.: 11/334,203

(22) Filed: Jan. 18, 2006

Related U.S. Application Data
(63) Continuation of application No. PCT/EP04/07991, filed on Jul. 16, 2004.

(30) Foreign Application Priority Data
Jul. 18, 2003 (FR) 03/08828

(51) Int. Cl. B60C 9/02

(52) U.S. Cl. 152/556

(57) ABSTRACT

The invention relates to a tire P comprising a radial carcass reinforcement radially surmounted by a crown reinforcement formed of at least two working crown plies formed of metallic reinforcement elements, crossed from one ply to the next, forming angles of between 10 and 45° with the circumferential direction, and of at least one additional layer formed of circumferentially oriented metallic reinforcement elements. According to the invention, at least one additional layer is radially internal to the working crown layers, said additional layer having an axial width greater than the width of the axially widest working crown layer and the reinforcement elements of said additional layer being metallic reinforcement elements having a secant modulus at 0.7% elongation of between 10 and 120 GPa and a maximum tangent modulus of less than 150 GPa.

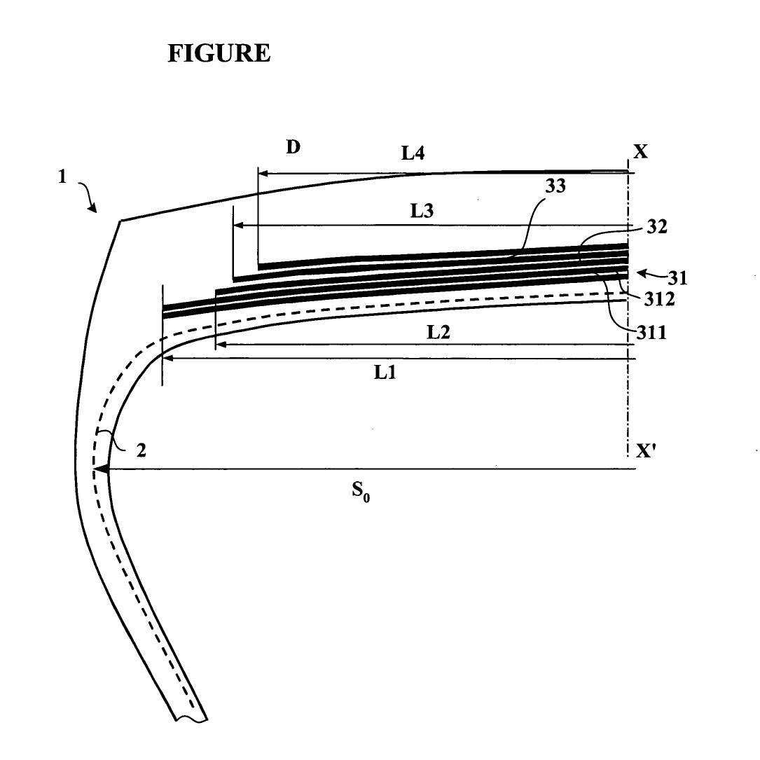

This application is a U.S. Continuation application of International Application PCT/EP2004/007991 filed Jul. 16, 2004.

The present invention relates to a tire having a radial carcass reinforcement, which is intended to be fitted on heavy vehicles such as lorries, buses, tractors, trailers etc., and relates more particularly to the crown reinforcement of such a tire.

The invention relates more specifically to a tire of the “heavy-vehicle” type, the ratio of the height on rim “H” to its maximum axial width “S” of which is at most equal to 0.80 and preferably less than 0.60.

Such a tire having a radial carcass reinforcement anchored within each bead to at least one bead wire comprises a crown reinforcement formed of at least two what are called “working” layers, radially superposed and formed of reinforcement elements which are parallel to each other in each layer and crossed from one layer to the next, forming with the circumferential direction of the tire angles the value of which may be between 10 and 45° in absolute value.

Cables are said to be inextensible when said cables have a relative elongation at most equal to 0.2% under a tensile force equal to 10% of the breaking load.

Cables are said to be elastic when said cables have a relative elongation at least equal to 4% under a tensile force equal to the breaking load.

The circumferential direction of the tire, or longitudinal direction, is the direction corresponding to the periphery of the tire and defined by the direction of rolling of the tire.

The transverse or axial direction of the tire is parallel to the axis of rotation of the tire.

The radial direction is a direction intersecting and perpendicular to the axis of rotation of the tire.

The axis of rotation of the tire is the axis around which it rotates in normal use.

A radial or meridian plane is a plane containing the axis of rotation of the tire.

The circumferential median plane, or equatorial plane, is a plane which is perpendicular to the axis of rotation of the tire and divides the tire into two halves.

In many cases, the Applicant has found that several quality criteria of the tire in question, in particular for use on heavy vehicles, may be improved by the presence in the crown reinforcement, radially between said working crown plies, of an additional ply formed of metallic elements oriented substantially parallel to the circumferential direction.

Mention may be made of application FR 2 744 955 which, with the aim of lowering the operating temperature of a “heavy-vehicle” tire by means of an economical and effective solution, advocates using an additional ply of circumferential reinforcement elements having an axial width at least equal to 1.05 times the width of the widest working ply, the reinforcement elements of said additional ply having a larger diameter than the diameter of the elements of the working plies.

In the context above, the additional ply may be formed of continuous cables made of steel referred to as “semi-elastic” cables, that is to say, cables having relative elongations at break of greater than 2%. These cables make it possible to obtain the level of rigidity suitable for distributing the circumferential tension between the working crown plies and the additional ply well. Said cables are advantageously said to be “bimodular”, that is to say having a curve representing the tensile stress as a function of the relative elongation, having shallow gradients for the low elongations and a substantially constant, steep gradient for the higher elongations. The very low modulus before curing, for elongations of less than 2%, makes it possible to increase the circumferential development of the additional ply during curing of the tire.

The additional ply may also be formed of metal cables made of steel which are oriented circumferentially and cut so as to form sections of a length very much less than the circumferential length of the ply, the cuts between sections being axially offset the from each other. Such a embodiment makes it possible to impart the desired rigidity, whatever it may be, to the additional ply in simple manner.

The choice of the elastic or cut cables for the reinforcement of the additional ply does not permit the best fatigue resistance of said ply, either as a consequence of a reduction in the breaking load of the elastic cables, or as a consequence of the existence of concentrations of stress in the calendering mix of the cut cables. The structure thus described therefore adversely affects the endurance of the additional ply itself.

International application WO 99/24 270 teaches that better resistance to separation between carcass ply and the crown reinforcement, better resistance to separation between crown plies and better fatigue resistance of the circumferential reinforcement elements of the additional ply may be obtained by using as reinforcement elements of the additional ply metallic elements which are circumferentially continuous and undulate in the plane of the ply, the undulations of said elements being parallel to each other, in phase and oriented circumferentially such that the ratio α/λ of the amplitude a to the wavelength λ decreases axially from the centre to the edges of said ply, being minimum at said edges.

Other documents, such as document EP 0 980 770, describe, for uses on heavy vehicles, the presence in the crown reinforcement, radially to the inside of the working crown plies, of an additional ply formed of metallic elements which are oriented substantially parallel to the circumferential direction.

According to the aforementioned document, the reinforcement elements of the additional ply are metallic, circumferentially continuous elements which undulate in the plane of the ply and the additional ply has axial ends which are axially to the outside of the axial ends of the working crown plies. The position radially to the inside of the working crown plies of the additional ply results in greater stress on the reinforcement elements which constitute it and a reduction in the stress on the reinforcement elements of the working crown plies in the longitudinal direction.

The tests carried out with this type of tire have shown that although the endurance of the tires thus produced is satisfactory, premature wear phenomena appear at the level of the shoulders of the tires.

The object of the invention is to overcome this drawback, and it advocates a solution which permits better wear resistance while retaining good results relating to the endurance of the tires.

This object has been achieved according to the invention by a tire comprising a radial carcass reinforcement radially surmounted by a crown reinforcement formed of at least two working crown layers formed of metallic reinforcement elements, crossed from one layer to the next, forming angles of between 10 and 45° with the circumferential direction, and of at least one additional layer, formed of circumferentially oriented metallic reinforcement elements, at least one additional layer being radially internal to the working crown layers, said additional layer having an axial width greater than the width of the axially widest working crown layer and the reinforcement elements of said additional layer being metallic reinforcement elements having a secant modulus at 0.7% elongation of between 10 and 120 GPa and a maximum tangent modulus of less than 150 GPa.

According to a preferred embodiment, the secant modulus of the reinforcement elements at 0.7% elongation is less than 100 GPa and greater than 20 GPa, preferably between 30 and 90 GPa and more preferably still less than 80 GPa.

Preferably also, the maximum tangent modulus of the reinforcement elements is less than 130 GPa and more preferably still less than 120 GPa.

The moduli expressed above are measured on a curve of tensile stress as a function of the elongation determined with a prestress of 20 MPa referred to the metal section of the reinforcement element, the tensile stress corresponding to a measured tension referred to the metal section of the reinforcement element.

The moduli of the same reinforcement elements may be measured on a curve of tensile stress as a function of the elongation determined with a prestress of 10 MPa referred to the overall section of the reinforcement element, the tensile stress corresponding to a measured tension referred to the overall section of the reinforcement element. The overall section of the reinforcement element is the section of a composite element formed of metal and of rubber, the latter having in particular penetrated the reinforcement element during the phase of curing the tire.

According to this formulation relative to the overall section of the reinforcement element, the reinforcement elements of at least one layer of circumferential reinforcement elements are metallic reinforcement elements having a secant modulus at 0.7% elongation of between 5 and 60 GPa and a maximum tangent modulus of less than 75 GPa.

According to a preferred embodiment, the secant modulus of the reinforcement elements at 0.7% elongation is less than 50 GPa and greater than 10 GPa, preferably between 15 and 45 GPa and more preferably still less than 40 GPa.

Preferably also, the maximum tangent modulus of the reinforcement elements is less than 65 GPa and more preferably still less than 60 GPa.

According to one preferred embodiment, the reinforcement elements of at least one additional layer are metallic reinforcement elements having a curve of tensile stress as a function of the relative elongation having shallow gradients for the low elongations and a substantially constant, steep gradient for the higher elongations. Such reinforcement elements of at least one additional layer are usually referred to as “bi-modular” elements.

According to a preferred embodiment of the invention, the substantially constant, steep gradient appears from a relative elongation of between 0.1% and 0.5% onwards.

The different characteristics of the reinforcement elements mentioned above are measured on reinforcement elements taken from tires.

Reinforcement elements which are more particularly suitable for producing at least one additional layer according to the invention are for example assemblies of formula 21.23, the construction of which is 3×(0.26+6×0.23) 4.4/6.6 SS; this stranded cable is formed of 21 elementary cords of formula 3×(1+6), with 3 strands twisted together each formed of 7 cords, one cord forming a central core of a diameter of 26/100 mm and 6 wound cords of a diameter of 23/100 mm. Such a cable has a secant modulus at 0.7% equal to 45 GPa and a maximum tangent modulus equal to 98 GPa, both measured on a curve of tensile stress as a function of the elongation determined with a prestress of 20 MPa referred to the metal section of the reinforcement element, the tensile stress corresponding to a measured tension referred to the metal section of the reinforcement element. On a curve of tensile stress as a function of the elongation determined with a prestress of 10 MPa referred to the overall section of the reinforcement element, the tensile stress corresponding to a measured tension referred to the overall section of the reinforcement element, this cable of formula 21.23 has a secant modulus at 0.7% of 23 GPa and a maximum tangent modulus of 49 GPa.

In the same manner, another example of reinforcement elements is an assembly of formula 21.28, the construction of which is 3×(0.32+6×0.28) 6.2/9.3 SS. This cable has a secant modulus at 0.7% of 56 GPa and a maximum tangent modulus of 102 GPa, both measured on a curve of tensile stress as a function of the elongation determined with a prestress of 20 MPa referred to the metal section of the reinforcement element, the tensile stress corresponding to a measured tension referred to the metal section of the reinforcement element. On a curve of tensile stress as a function of the elongation determined with a prestress of 10 MPa referred to the overall section of the reinforcement element, the tensile stress corresponding to a measured tension referred to the overall section of the reinforcement element, this cable of formula 21.28 has a secant modulus at 0.7% of 27 GPa and a maximum tangent modulus of 49 GPa.

The tests carried out showed that the tire thus produced according to the invention makes it possible to maintain satisfactory endurance properties associated with a wear resistance in particular at the level of the edges of the tread which is distinctly improved compared with the tire as described previously. The inventors have demonstrated that the reinforcement elements of the additional layer according to the invention permit the manufacture of a tire, in particular the shaping thereof, and make it possible to obtain satisfactory rigidity at the level of the edges of the tread which permits satisfactory wear resistance. In fact, in order to be able to manufacture the tire in question as simply as possible and at as low a cost as possible, the reinforcement, according to the invention, must have, for the low forces of traction imparted parallel to the direction of the reinforcement elements, a certain relative elongation, which is necessary for the possibility of having a greater circumferential development of the crown reinforcement upon the operations of building, finishing and vulcanization of the tire.

Furthermore, the radially inner position of the additional layer relative to the working crown layers results in satisfactory endurance performance in particular as far as the working crown layers and the carcass reinforcement are concerned.

According to a preferred embodiment of the invention, the crown reinforcement is composed of at least two additional layers formed of circumferentially oriented metallic reinforcement elements. Such an embodiment makes it possible to obtain a satisfactory rigidity at the level of the shoulders of the tire with conventional diameters of reinforcement elements.

More preferably still, all the additional layers formed of circumferentially oriented metallic reinforcement elements are radially internal to the working crown layers.

Such an embodiment makes it possible to improve still further the endurance properties of the working crown layers and the carcass reinforcement.

One advantageous variant of the invention provides for the crown reinforcement furthermore to comprise a triangulation layer formed of metallic reinforcement elements forming angles greater than 60° with the circumferential direction.

Preferably, according to this variant embodiment of the invention, the triangulation layer is radially internal to the other layers of the crown reinforcement.

The presence of a triangulation ply is in particular beneficial to the endurance of the carcass reinforcement, by preventing the risks of compression thereof.

More advantageously still, the crown reinforcement furthermore comprises a protective layer radially external to the other layers of the crown reinforcement. Such a protective layer imparts in particular protection of the crown reinforcement from the risk of perforation of the tread. The reinforcement elements of the protective layer are advantageously elastic. The angles of these reinforcement elements are preferably identical to those of the radially adjacent working layer for furthermore preventing the risk of oxidation of said radially adjacent working layer.

The protective ply may have an axial width less than the axial width of the least wide working ply, but advantageously sufficient to cover totally the coupling zone between the two working crown plies, and all the more advantageously in that the tread of the tire in question comprises a circumferential or quasi-circumferential groove axially arranged radially over the coupling zone between the two working plies. Said protective ply may also have an axial width greater than the axial width of the least wide working ply, such that it covers the edges of the least wide working ply and, in the case of the radially upper ply as being the least wide, such that it is coupled, in the axial extension of the additional reinforcement, with the widest working crown ply.

According to another embodiment of the invention, the protective ply may have an axial width greater than the axial width of the axially widest additional layer, formed of circumferentially oriented metallic reinforcement elements. According to this embodiment of the invention, during a retreading operation, the layer of reinforcement elements liable to be bared, over the entire axial width of the crown reinforcement, is a layer of reinforcement elements in which said reinforcement elements advantageously form an angle with the circumferential direction, or more exactly are not circumferential reinforcement elements.

### BRIEF DESCRIPTION OF THE DRAWING

Other advantageous details and characteristics of the invention will become apparent hereafter from the description of an example of an embodiment with reference to the only FIGURE.

The only FIGURE represents a view in meridian section of a diagram of a crown reinforcement according to the invention.

### DETAILED DESCRIPTION OF THE DRAWING

The FIGURE is not shown to scale in order to simplify understanding thereof.

The tire 1, of dimension 495/45 R22.5, comprises a radial carcass reinforcement, formed of a single ply 2 of inextensible metal cables, which is anchored within each bead (the beads are not shown in the FIGURE). Said carcass reinforcement 2 is radially surmounted by a crown reinforcement 3, which itself is surmounted by a tread 5. The crown reinforcement 3 is composed, radially from the inside to the outside:

of an additional reinforcement 31, formed of two identical layers 311, 312, which is formed of metal 21×28 cables made of steel, which are of “bimodular” type and circumferential (cables forming an angle within the range 0°±2.5° with the circumferential direction are referred to as circumferential);

the additional reinforcement 31 being covered with a first working crown ply 32 formed of wrapped metal 27×23 cables, which are made of steel and inextensible (cables having a relative elongation at most equal to 2% at a force equal to 10% of their breaking load are referred to as inextensible), said cables having a diameter of 1.3 mm, being parallel to each other in the ply and arranged at a pitch of 2.5 mm (measured perpendicular to said cables). Said cables are oriented relative to the circumferential direction at an angle α, of between 10° and 45° and in the case described equal to 18°;

the first working crown ply 32 being covered by the second working crown ply 33 formed of wrapped metal 27×23 cables identical to those of the first ply 32, arranged at the same pitch and forming with the circumferential direction an angle β, opposed to the angle α of the cables of the first ply, and in the case described equal to said angle α (but possibly being different from said angle α);

the crown reinforcement 3 being finished off by a ply 34 of metal cables made of steel referred to as “elastic” cables, which are oriented relative to the circumferential direction at an angle χ of the same direction as the angle β and equal to said angle β (but possibly being different therefrom), said ply 34 being what is called a protective ply, and elastic cables being cables having a relative elongation greater than 4% at break.

The maximum axial width L₃₂ of the first working ply (32) is equal to 300 mm. The axial width L₃₃ of the second working ply (33) is equal to 280 mm. As for the overall axial width L₃₁ of the additional ply (31), it is equal to 400 mm. The last crown ply (34), referred to as “protective ply”, has a width L₃₄ substantially equal to 270 mm.

1- A tire comprising a radial carcass reinforcement radially surmounted by a crown reinforcement formed of at least two working crown layers formed of metallic reinforcement elements, crossed from one layer to the next, forming angles of between 10 and 45° with the circumferential direction, and of at least one additional layer formed of circumferentially oriented metallic reinforcement elements, wherein at least one additional layer is radially internal to the working crown layers, wherein said additional layer has an axial width greater than the width of the axially widest working crown layer and wherein the reinforcement elements of said additional layer are metallic reinforcement elements having a secant modulus at 0.7% elongation of between 10 and 120 GPa and a maximum tangent modulus of less than 150 GPa.

2- A tire according to claim 1, wherein the secant modulus of the reinforcement elements at 0.7% elongation is less than 100 GPa, preferably greater than 20 GPa and preferably still of between 30 and 90 GPa.

3- A tire according to claim 1, wherein the maximum tangent modulus of the reinforcement elements is less than 130 GPa and preferably less than 120 GPa.

4- A tire according to claim 1, wherein the reinforcement elements of said additional layer are metallic reinforcement elements having a curve of tensile stress as a function of the relative elongation having shallow gradients for the low elongations and a substantially constant, steep gradient for the higher elongations.

5- A tire according to claim 1, wherein the crown reinforcement is composed of at least two additional layers formed of circumferentially oriented metallic reinforcement elements.

6- A tire according to claim 1, wherein all the additional layers formed of circumferentially oriented metallic reinforcement elements are radially internal to the working crown layers.

7- A tire according to claim 1, wherein the crown reinforcement furthermore comprises a triangulation layer formed of metallic reinforcement elements forming angles greater than 60° with the circumferential direction.

8- A tire according to claim 7, wherein the triangulation layer is radially internal to the other layers of the crown reinforcement.

9- A tire according to claim 1, wherein the crown reinforcement furthermore comprises a protective layer and wherein it is radially external to the other layers of the crown reinforcement.

10- A tire according to claim 1, wherein the reinforcement elements of said additional layer are metallic assemblies of type 21.23 or 21.28.
